(19) United States
(12) Patent Application Publication
(10) Pub. No.: US 2011/0285064 A1
(43) Pub. Date: Nov. 24, 2011

(54) TIRE MOLD AND MANUFACTURING METHOD OF PNEUMATIC TIRE

(75) Inventor: Masaaki Ohara, Osaka (JP)

(73) Assignee: TOYO TIRE & RUBBER CO., LTD., Osaka (JP)

(21) Appl. No.: 13/100,340

(22) Filed: May 4, 2011

(30) Foreign Application Priority Data
May 18, 2010 (JP) 2010-113866

(51) Int. Cl. B29D 30/00

(52) U.S. Cl. 264/552; 425/28.1

(57) ABSTRACT

A tire mold has an annular rough surface molding portion extending along a circumferential direction in a region of a tire molding surface for molding a side wall portion. The rough surface molding portion is provided with a projection extending spirally along a circumferential direction at a protruding height between 5 and 300 μm.

### BACKGROUND OF THE INVENTION

1. Field of the Invention

The present invention relates to a tire mold for cure molding a tire, and a manufacturing method of a pneumatic tire using the tire mold.

2. Description of the Related Art

In cure molding of a tire, an outer surface of an uncured tire is likely to be stuck to a tire molding surface of a tire mold, and an adhesive failure as shown in FIG. 11 may be generated by a rubber flow defect caused thereby. The adhesive failure is recognized as a region which is continuously peeled or depressed in a circumferential direction in the tire outer surface, and is remarkably generated particularly in a side wall portion. Further, such a rubber flow defect promotes an air residual between the tire molding surface and the tire outer surface, and causes a molding sink called a lightness or a bare generated on the outer surface of the cured tire.

In Japanese Unexamined Patent Publication No. H06-106921, there is described a pneumatic tire structured such that an outer surface of a side wall portion is partitioned into a plurality of fan-shaped regions which are adjacent in a circumferential direction, and a difference of surface roughness is made equal to or more than 50 μm between the adjacent fan-shaped regions, for making inconspicuous a stripe-like irregularity trace generated by a joint portion of a carcass ply. Further, the publication No. H06-106921 describes changing a surface roughness of a tire molding surface of a tire mold for molding such a tire, and it is considered to be possible to improve a flow property of the rubber by suppressing an adhesion of an uncured tire at the time of cure molding, as far as the surface roughness corresponding to the fan-shaped region is rough.

However, in the tire mold mentioned above, since it is necessary to change the surface roughness between the fan-shaped regions which are adjacent in the circumferential direction, it is complicated and difficult to apply a machine work to the tire molding surface, and a sandblast work or the like is practically applied. Accordingly, a magnitude of concavity and convexity and a precision of a forming density are lowered in comparison with the tire molding surface to which the machine work is applied, and if the used mold is different, there is a case that a difference is generated in a tire appearance such as a gloss. Further, since air flows in a random direction between the tire molding surface and the tire outer surface at the time of the cure molding, there is a risk that the air causes a standstill so as to stay behind.

### SUMMARY OF THE INVENTION

The present invention has been made in view of the above situation, and an object of the present invention is to provide a tire mold and a manufacturing method of a pneumatic tire which can secure an uniformity of a tire appearance while suppressing a fault due to a rubber flow defect at the time of a cure molding such as an adhesive failure and a lightness.

The object can be achieved by the following present invention. That is, a tire mold according to the present invention comprises an annular rough surface molding portion extending along a circumferential direction in a region of a tire molding surface for molding a side wall portion, the rough surface molding portion being provided with a projection extending spirally along a circumferential direction at a protruding height between 5 and 300 μm.

In the tire mold, since the projection having the protruding height between 5 and 300 μm is provided in the rough surface molding portion provided in the region for molding the side wall portion, the rough surface molding portion is formed correspondingly rough, and it is possible to secure a flow property of the rubber by suppressing an adhesion of an uncured tire at the time of the cure molding. Further, since the projection extends spirally along the circumferential direction, the air between the tire molding surface and the tire outer surface tends to flow in the circumferential direction, and it is possible to reduce a residual of the air by suppressing the standstill. Further, it is easy to apply the machine work to the rough surface molding portion, and it is possible to secure the uniformity of the tire appearance such as the gloss by precisely controlling the magnitude and the forming density of the projection.

In the tire mold in accordance with the present invention, it is preferable that the rough surface molding portion includes a plurality of curved surfaces in which curvatures are differentiated, and a pitch or a protruding height of the projection is larger in the curved surface having a smaller radius of curvature than the curved surface having a larger radius of curvature, in a cross section which is obtained by cutting by a plane including a tire center axis. In the cure molding of the tire, the contact pressure of the tire outer surface tends to be weak in the position in which the radius of curvature of the tire molding surface is small, and there is accordingly a risk that the adhesive failure and the lightness are generated. On the contrary, with the above structure of the present invention, since the pitch or the protruding height of the projections is relatively larger in the position in which the radius of curvature is small, it is possible to effectively suppress the adhesive failure or the like by increasing the contact pressure of the tire outer surface.

In the pneumatic tire in accordance with the present invention, it is preferable that a protruding height of the projection is changed along an extending direction of the projection. In this case, at the time of cure molding the tire, since the outer surface of the uncured tire comes into contact in advance with the position in which the protruding height of the projection is large, and comes into contact in arrear with the position in which the protruding height of the projection is small, it is possible to effectively suppress the generation of the adhesive failure, by increasing the contact pressure in the position in which the protruding height is large.

In the tire mold in accordance with the present invention, it is preferable that the pitch of the projection is between 30 and 500 μm. Accordingly, the rough surface molding portion becomes more moderately rough, and it is possible to effectively suppress the adhesion of the uncured tire by reducing the flow resistance of the rubber. In order to enhance the operation and effect mentioned above, it is preferable that the pitch of the projections is larger than the protruding height of the projections.

In the tire mold in accordance with the present invention, it is preferable that the tire molding surface is provided with a radial groove which has a larger groove depth than a protruding height of the projection and vertically crosses the rough surface molding portion. With the structure mentioned above, since the air between the tire molding surface and the tire outer surface can flow through the radial groove, it is possible to well prevent the generation of the lightness by reducing the residual of the air between the projections.

Further, the manufacturing method of the pneumatic tire according to the present invention is provided with a step of cure molding the tire by using any tire mold mentioned above. In this method, it is possible to suppress the fault caused by the rubber flow defect at the time of the cure molding, such as the adhesive failure and the lightness, by reducing the residual of the air while securing the flow property of the rubber by means of the tire molding surface provided with the rough surface molding portion as mentioned above. All the same time, it is possible to secure the uniformity of the tire appearance such as the gloss, by precisely controlling the magnitude and the forming density of the projection in the rough surface molding portion.

In the manufacturing method of the pneumatic tire in accordance with the present invention, it is preferable that the step of cure molding the tire is carried out such that an exposure position of a rubber interface in a side wall portion of the tire is pressed against the rough surface molding portion. In the exposure position of the rubber interface, there is a tendency that the adhesive failure and the lightness tend to be generated in correspondence to the difference of flow property caused by the different kinds of rubbers. On the contrary, according to the above method of the present invention, since the position which tends to generate such a fault is pressed against the rough surface molding portion, it is possible to accurately suppress the generation of the adhesive failure and the lightness.

### BRIEF DESCRIPTION OF THE DRAWINGS

FIG. 1 is a vertical cross sectional view schematically showing an example of a tire mold according to the present invention;

FIG. 2 is a cross sectional view as seen from an arrow A-A in FIG. 1;

FIG. 3 is a plan view schematically showing a rough surface molding portion and a cross sectional perspective view showing a part thereof;

FIG. 4 is an enlarged cross-sectional view showing a substantial part of the rough surface molding portion;

FIG. 5 is a side view of a projection according to other embodiment of the present invention;

FIG. 6(a) is a plan view of a rough surface molding portion provided with a radial groove and a circumferential groove, and FIG. 6(b) is a cross sectional perspective view showing a part thereof;

FIG. 7 is an enlarged cross-sectional view showing a substantial part of the rough surface molding portion according to other embodiment of the present invention;

FIG. 8 is a cross sectional view explaining a setting of an uncured tire to the tire mold; and

FIG. 9 is a perspective view showing an example of a molded pneumatic tire;

FIG. 10 is a cross sectional view of a tire meridian for explaining an exposure position of a rubber interface; and

FIG. 11 is a perspective view of a pneumatic tire for explaining an adhesive failure.

### DETAILED DESCRIPTION OF THE PREFERRED EMBODIMENTS

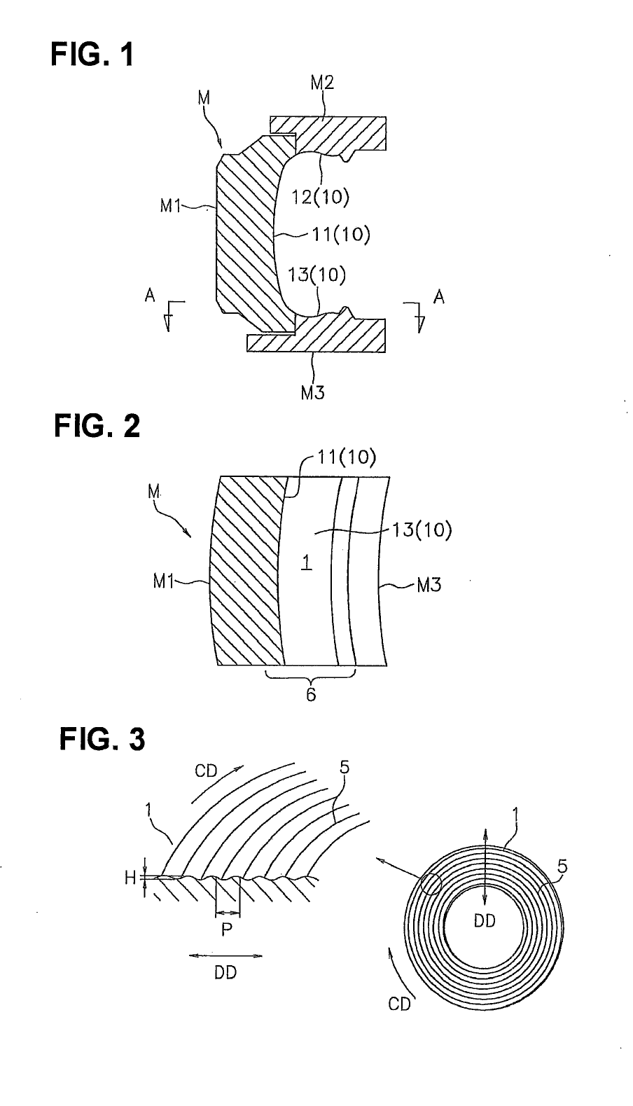

An embodiment of the present invention will be explained with reference to the drawings. FIG. 1 shows a schematic cross sectional view of a tire mold M (hereinafter, referred to as mold M) as a cure metal mold for a tire. At the time of the cure molding, the uncured tire is set to the mold M by setting the tire axial direction to up and down, and the outer surface of the tire is brought into contact with the tire molding surface 10. The mold M is provided with a tread mold portion M1 for molding the tread portion, and side mold portions M2 and M3 for molding the side wall portions, and inner surfaces 11 to 13 of the respective mold portions construct the tire molding surface 10. Although not illustrated, an irregularity shape corresponding to the tread pattern is formed in the inner surface 11 of the tread mold portion M1.

The mold M is provided with an annular rough surface molding portion along a circumferential direction in a region which molds the side wall portion, of the tire molding surface 10. In the present embodiment, as shown in FIG. 2, the rough surface molding portion 1 is formed in the region 6 for molding the side wall portion in the lower side of the tire molding surface 10. The region 6 extends over a part of the inner surface 11 of the tread mold portion M1 and the inner surface 13 of the side mold portion M3, and corresponds to a region running into a tread contact end from a bead heel of the tire. The rough surface molding portion 1 may occupy the entire range of the region 6, however, may be configured by a part thereof. There is a case where a design such as a logo or a side protector is formed in the region 6, however, the rough surface molding portion 1 may be formed optionally therein.

As shown in FIG. 3, the rough surface molding portion 1 is provided with a projection 5 extending spirally along a circumferential direction CD at a protruding height H between 5 and 300 μm. The protruding height H is a height from a peak to a valley of the projection 5, and a maximum height Rz in the rough surface molding portion 1 becomes 5 to 300 μm. The maximum height Rz corresponds to the maximum height roughness Rz defined in JISB0601:2001, and are based on the regulation. Further, rules and procedures for an assessment and characteristics of instruments are based on the provisions of JISB0633:2001 and JISB0651:2001.

The maximum height Rz is determined as an average value of measurement data which is obtained every five continuous sampling lengths along the radial direction DD. A sampling length and an evaluation length are defined in correspondence to a surface texture of the rough surface molding portion 1, and in the case where the maximum height Rz is equal to or less than 10 μm, the sampling length is 0.8 mm, the evaluation length is 4 mm, in the case where the maximum height Rz exceeds 10 μm and is equal to or less than 50 μm, the sampling length is 2.5 mm, the evaluation length is 12.5 mm, and in the case where the maximum height Rz exceeds 50 μm, the sampling length is 8 mm, the evaluation length is 40 mm.

In this mold M, the rough surface molding portion 1 is formed properly rough by the projection 5, and it is possible to secure a flow property of the rubber by suppressing the adhesion of the uncured tire as mentioned below at the time of cure molding. Further, since the projection 5 extends spirally along the circumferential direction CD, the air between the rough surface molding portion 1 and the tire outer surface tends to flow in the circumferential direction, and it is possible to reduce a residual of the air by suppressing the standstill. Accordingly, it is possible to suppress the fault caused by the rubber flow defect at the time of the cure molding, such as the adhesive failure and the lightness.

Further, it is easy to apply the machine work to the rough surface molding portion 1 in which the projection 5 continuously extends spirally along the circumferential direction CD, and it is possible to precisely control a magnitude and a forming density of the projection. As a result, even if the used molds are different, it is possible to evenly secure a tire appearance such as a gloss, and it is possible to enhance an appearance quality. The rough surface molding portion 1 can be machine worked by an inexpensive machine tool, and can be worked by moving a tool in such a manner that a stripe line of the work extends spirally along the circumferential direction CD.

In the case that the protruding height H of the projection 5 is less than 5 μm, the roughness of the rough surface molding portion 1 is not sufficient, whereby the uncured tire is likely to be stuck, and the flow resistance becomes high so as to be liable to cause the rubber flow defect. It is more preferable that the protruding height H is equal to or more than 10 μm for sufficiently securing the roughness of the rough surface molding portion 1. Further, in the case that the protruding height H exceeds 300 μm, a deep micro concave portion is formed in the tire outer surface by the projection, and there is a risk that a strain is concentrated on a valley of the concave portion so as to form an initial point of a crack.

It is preferable that the projection 5 is provided as a triangular shape in a cross section as in the present embodiment. Accordingly, it is possible to effectively suppress the adhesive failure and the lightness by increasing the contact pressure of the uncured tire at the time of the cure molding. Note that, the present invention is not limited thereto, but may be structured such that the cross sectional shape of the projection is a trapezoidal shape or such a mountain shape that a top portion collapses.

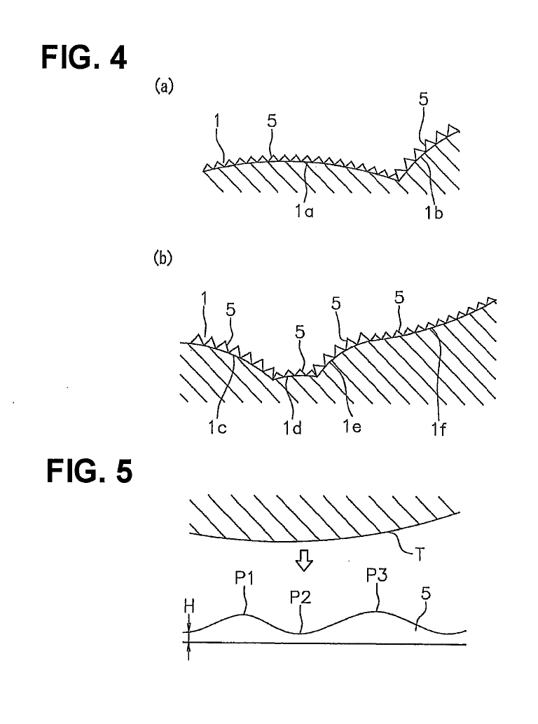

FIGS. 4(a) and 4(b) show a substantial part of the rough surface molding portion 1 which is cut by a plane including a tire center axis, and correspond to a partly enlarged view of FIG. 1. In FIG. 4(a), the rough surface molding portion 1 includes a plurality of curved surfaces 1a and 1b in which their curvatures are differentiated, and among them, a pitch and a protruding height of the projection 5 is made larger in the curved surface 1b having a smaller radius of curvature than those of the curved surface 1a having a larger radius of curvature. Accordingly, it is possible to make the contact pressure of the tire outer surface in the curved surface 1b relatively higher at the time of the cure molding, and it is possible to effectively suppress the adhesive failure or the like.

FIG. 4(b) shows a case that a side protector is formed, and the rough surface molding portion 1 includes a plurality of curved surfaces 1c to 1f in which their curvatures are differentiated. In the adjacent curves surfaces 1c and 1d, the pitch and the protruding height of the projection 5 are larger in the curved surface is having the smaller radius of curvature than those of the curved surface 1d having the larger radius of curvature, thereby achieving the suppression of the adhesive failure or the like as mentioned above. The same applies to a relationship between the adjacent curved surfaces 1d and 1e, and between the adjacent curved surfaces 1e and 1f. In the example in FIGS. 4(a) and 4(b), both the pitch and the protruding height are differentiated, however, one of the pitch and the protruding height may be uniform and the other may be differentiated.

As a preferred embodiment of the present invention, there can be listed up a structure in which a protruding height H of the projection 5 is changed along an extending direction (a lateral direction in FIG. 5) of the projection 5, as shown in FIG. 5. In this case also, the protruding height H is changed within a range between 5 and 300 μm. In the present embodiment, the protruding height H is periodically changed in such a manner that a peak of the projection 5 is formed as a wavy shape, and this period may be differentiated between the adjacent projections 5 in the radial direction.

In the projection 5 mentioned above, since an outer surface of a side wall portion of an uncured tire T comes into contact in advance with positions P1 and P3 in which the protruding height H is larger, and comes into contact in arrear with a position P2 in which the protruding height H is smaller, at the time of cure molding the tire, it is possible to effectively suppress the generation of the adhesive failure by increasing the contact pressure particularly at the positions P1 and P3. In this case, even in the case that a peeling or a depression is generated at the position P2 in which the contact pressure is relatively low, it is possible to prevent the peeling or the depression from being continuously formed in the circumferential direction so as to prevent the adhesive failure from being generated, since the contact pressure is higher at the positions P1 and P3 which are positioned in both sides thereof.

It is preferable that the pitch P of the projection 5 is between 30 and 500 μm, whereby the rough surface molding portion 1 becomes moderately rough, and it is possible to effectively suppress the adhesion of the uncured tire by reducing the flow resistance of the rubber. It is preferable that the pitch P is larger than the protruding height H for enhancing the operation and effect mentioned above. As shown in FIG. 3, the pitch P corresponds to a period of the projections 5 which are lined up in the radial direction DD, and a mean width RSm defined by JISB0601:2001 becomes 30 to 500 μm. With regard to the mean width RSm, rules and procedures for the assessment, characteristics of instruments, a sampling length and an evaluation length are based on those which are described with regard to the maximum height Rz.

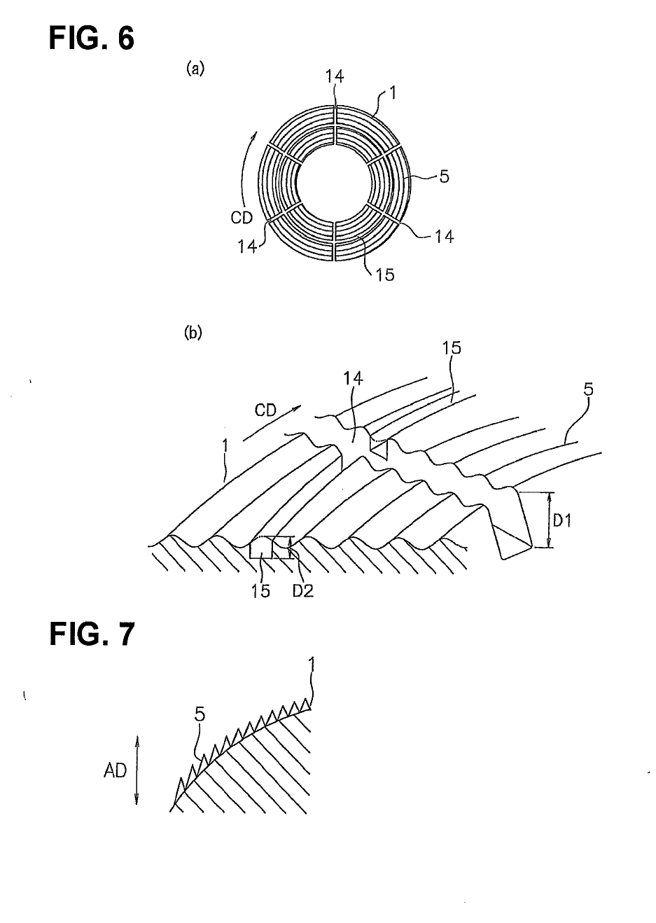

As shown in FIGS. 6(a) and 6(b), a tire molding surface 10 may be provided with a radial groove 14 which has a larger groove depth D1 than the protruding height of the projection and vertically crosses the rough surface molding portion 1. In this case, since the air can flow through the radial groove 14, it is possible to well prevent the lightness from being generated by reducing the residual of the air between the projections 5. The groove depth D1 of the radial groove 14 is a depth from the peak of the projection 5 to the valley of the radial groove 14, and is preferable to be 5 to 50 times of the protruding height H of the projection 5. The radial grooves 14 are provided so as to be spaced in the circumferential direction, for example, 6 to 10 radial grooves 14 are provided in a radial pattern.

In an example in FIG. 6, the tire molding surface 10 is provided with a circumferential groove 15 which has a larger groove depth D2 than the protruding height of the projection 5 and is orthogonal to the radial groove 14, thereby further enhancing an exhaust efficiency. The groove depth D2 of the circumferential groove 15 is a depth from the peak of the projection 5 to a valley of the circumferential groove 15, and is preferable to be 0.5 to 2 times of the protruding height H of the projection 5. The circumferential groove 15 is provided annularly along the circumferential direction CD, and a plurality of circumferential grooves 15 may be arranged concentrically. The radial groove 14 and the circumferential groove 15 can be provided by the machine work after finishing the rough surface molding portion 1 by the machine work.

In FIGS. 4(a) and 4(b), there is shown the example in which each of the projections 5 protrudes in a normal line direction of a curved surface configuring the rough surface molding portion 1, however, the projections 5 may protrude uniformly in a tire axial direction AD (an up and down direction in FIG. 1) as exemplified in FIG. 7. Since the outer surface of the side wall portion of the tire comes close to the tire molding surface 10 from the tire axial direction at the time of cure molding the tire, the contact pressure of the tire outer surface is enhanced by this structure. Further, since the light is evenly reflected at the outer surface of the side wall portion in the tire after being molded, it is possible to improve an appearance quality by suppressing a shading.

Since the rubber flow defect at the time of the cure molding is particularly remarkable in a region (corresponding to a region 7 in FIG. 9) from a maximum width position of the tire to a rim line, it is desirable to form the rough surface molding portion 1 in the region of the tire molding surface 10. Further, since the adhesive failure and the lightness tend to be generated at an exposure position of the rubber interface of the tire in correspondence to the difference of the flow property caused by the different kinds of rubbers, as mentioned below, it is desirable to form the rough surface molding portion 1 in the region including the exposure position.

Next, a description will be given of a manufacturing method of the pneumatic tire according to the present invention, however, since it can be carried out in the same manner as the conventional tire manufacturing steps except a step of cure molding the tire, a description will be given only of the cure molding step. The manufacturing method of the pneumatic tire has a step of cure molding the tire by using a mold M provided with the rough surface molding portion 1 as mentioned above in the region for molding the side wall portion of the tire molding surface 10.

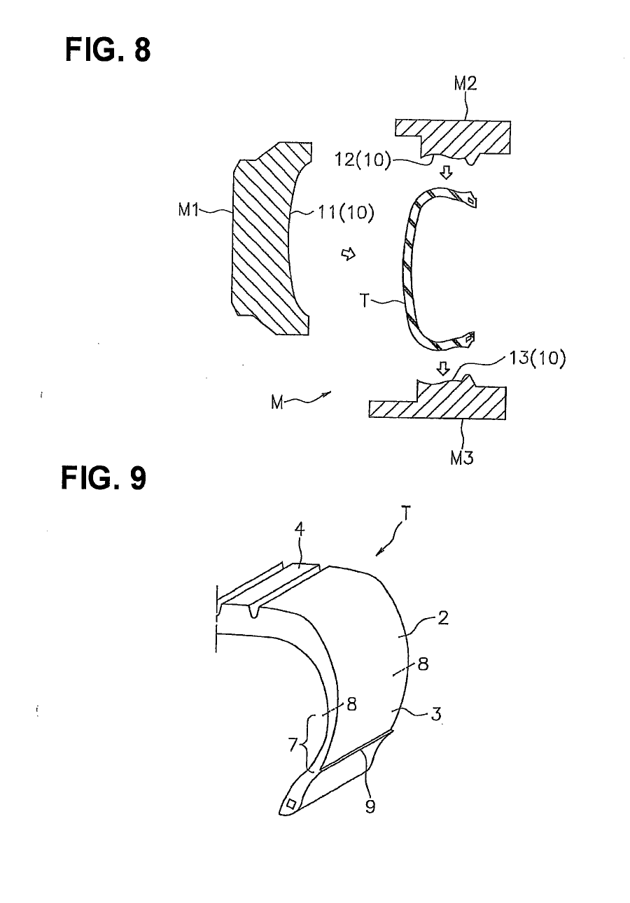

In the cure molding step, the uncured tire T before the cure molding is set as shown in FIG. 8, the tire molding surface 10 is thereafter pressed against the outer surface of the tire by clamping the mold M as shown in FIG. 1, and heat and pressure are applied to the tire T. At this time, since the residual of the air can be reduced while securing the flow property of the rubber as mentioned above in the rough surface molding portion 1, it is possible to suppress the generation of the fault such as the adhesive failure in the tire T after being molded. Further, since the magnitude and the forming density of the projection in the rough surface molding portion 1 can be precisely controlled, it is possible to secure a uniformity of the tire appearance such as the gloss.

FIG. 9 shows a pneumatic tire T which is manufactured via the cure molding step mentioned above. The pneumatic tire T is provided with a side wall portion 3 extending outward in a tire radial direction from a bead portion seating on a rim, and a tread portion 4 configuring a tread surface while being connected to an outer end of the side wall portion 3, and an annular rough surface portion 2 extending along a tire circumferential direction is formed in an outer surface of the side wall portion 3. The tire T can be constructed in the same manner as the normal pneumatic tire except for being provided with a rough surface portion 2, and is provided with a carcass and a belt which are not illustrated, in its inside.

The rough surface portion 2 is a portion which is molded by transcribing the rough surface molding portion 1. The rough surface portion 2 is provided with a concave groove extending spirally along the circumferential direction at a groove depth between 5 and 300 μm in correspondence to the projection 5 of the rough surface molding portion 1, and a maximum height Rz in its surface texture becomes 5 to 300 μm. This tire T becomes a tire in which the fault caused by the rubber flow defect at the time of the cure molding such as the adhesive failure and the lightness is suppressed in the rough surface portion 2, and the uniformity of the tire appearance is secured. Since the rubber flow defect is remarkable in the region 7 from a maximum width position 8 to a rim line 9, it is desirable to form the rough surface portion 2 at least in an outer surface of the region 7.

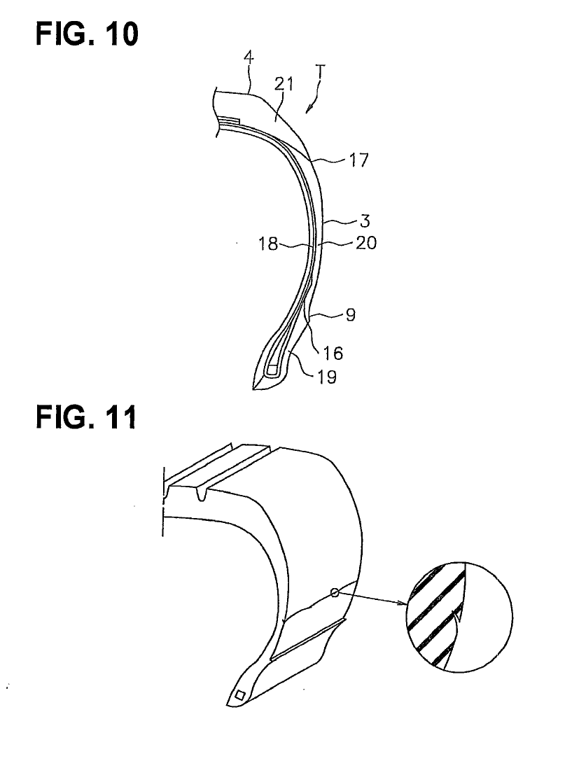

Exposure positions 16 and 17 of the rubber interface exist as shown in FIG. 10, on the outer surface of the side wall portion 3 of the tire T. In other words, plural kinds of rubbers which are suitable for the respective positions such as a rim strip rubber 19, a side wall rubber 20 and a tread rubber 21 are arranged in an outer side of a carcass 18, and reference numerals 16 and 17 denote the exposure positions of the rubber interface of them. Since there is a tendency that the adhesive failure and the lightness are generated in correspondence to the difference of the flow property caused by the different kinds of rubbers, at the positions 16 and 17, it is preferable to press the exposure positions 16 and 17 against the rough surface molding portion 1 so as to accurately suppress the generation of the adhesive failure and the lightness at the time of the cure molding.

The present invention is not limited to the embodiment mentioned above, but can be variously modified and changed within the scope of the present invention. In the embodiment mentioned above, there is shown the example in which the tire molding surface is constructed by three mold portions, however, the structure is not limited thereto, and it may be constructed, for example, by a pair of mold portions which are divided into two sections in the center of the tread portion. Further, an inner side in the tire diametrical direction of the side mold portion may be provided with a bead ring fitting the bead portion of the tire as an independent member.

What is claimed is:

1. A tire mold comprising an annular rough surface molding portion extending along a circumferential direction in a region of a tire molding surface for molding a side wall portion, the rough surface molding portion being provided with a projection extending spirally along a circumferential direction at a protruding height between 5 and 300 μm.

2. The tire mold according to claim 1, wherein the rough surface molding portion includes a plurality of curved surfaces in which curvatures are differentiated, and a pitch or a protruding height of the projection is larger in the curved surface having a smaller radius of curvature than the curved surface having a larger radius of curvature, in a cross section which is obtained by cutting by a plane including a tire center axis.

3. The tire mold according to claim 1, wherein a protruding height of the projection is changed along an extending direction of the projection.

4. The tire mold according to claim 1, wherein the pitch of the projection is between 30 and 500 μm.

5. The tire mold according to claim 1, wherein the tire molding surface is provided with a radial groove which has a larger groove depth than a protruding height of the projection and vertically crosses the rough surface molding portion.

6. A manufacturing method of a pneumatic tire comprising a step of cure molding the tire by using a tire mold according to claim 1.

7. The manufacturing method of a pneumatic tire according to claim 6, wherein the step of cure molding the tire is carried out such that an exposure position of a rubber interface in a side wall portion of the tire is pressed against the rough surface molding portion.
